(19) United States
(12) Patent Application Publication
(10) Pub. No.: US 2003/0119383 A1
(43) Pub. Date: Jun. 26, 2003

(54) Male contact

(76) Inventors: Noriaki Sai, Kawasaki (JP); Toshiaki Kohno, Kawasaki (JP); Masanori Wakui, Toyota (JP); Keiichi Itou, Toyota (JP); Kazuyuki Shiraki, Toyota (JP); Atushi Nishida, Toyota (JP)

Correspondence Address: JoAnn Dilloway, Barley Snyder, 126 East King Street, Lancaster, PA, 17602-2893, US

(21) Appl. No.: 10/332,090

(22) PCT Filed: Jul. 5, 2001
(86) PCT No.: PCT/JP01/05841

(30) Foreign Application Priority Data
Jul. 5, 2000 (JP) 2000-203541

(51) Int. Cl. H01R 4/10

(52) U.S. Cl. 439/877

(57) ABSTRACT

There is provided a male contact which is high in reliability of an electric contact with the female contact and has a mating section capable of being formed with compactness using a plate member having a plate thickness satisfying a desired strength. The male contact 1 has a mating section 10 formed in such a manner that two sheets of plate members 11 and 12, which individually extend from a base 20, are superposed on one another by folding on said base 20. Said mating section 10 has flat sections 15 extending in a mating direction P, wherein outer surfaces of said two sheets of plate members 11-1 and 12-1 are formed flat. A tip 13 of one 12 of said two sheets of plate members is folded to overlap a tip 14 of another plate member 11. This feature makes it hard to open the plate members 11 and 12 when the male contact is mated with the female contact.

### TECHNICAL FIELD

The present invention relates to a male contact formed by bending a sheet of metallic plate.

### BACKGROUND ART

There is well known, as shown in FIG. 10 to FIG. 14, a male contact having a mating section for mating with a female contact on one end of a base and a wire connecting section on another end of the base, the male contact being formed by punching processing and bending processing of a sheet of metallic plate.

FIG. 10 is a sectional view of a mating section of the conventional male contact taken along the direction perpendicular to the mating direction (cf. Japanese Toku-Kai-Hei 8-162191). A mating section 10a is formed in such a manner that both edge portions 51a and 51a extending in the mating direction of a sheet of plate member 50a represented by a broken line are folded (cf. arrows a), so that both the edge portions 51a and 51a are confronted with one another at the center of the plate member 50a.

FIG. 11 is a sectional view of a mating section of another conventional male contact taken along the direction perpendicular to the mating direction (cf. Japanese Toku-Kai-Hei 7-192793). A mating section 10b is formed in such a manner that both edge portions 51b and 51b extending in the mating direction of a sheet of plate member 50b represented by a broken line are wound (cf. arrows b), so that both the edge portions 51b and 51b are confronted with one another at the center of the plate member. Thus, the mating section 10b is different from the mating section 10a formed by folding of both the edge portions as shown in FIG. 10, and is provided with cavity sections 52b and 52b at both edges of the mating section 10b by winding.

FIG. 12 is a sectional view of a mating section of further another conventional male contact taken along the direction perpendicular to the mating direction (cf. Japanese Toku-Kai-Hei 8-162191). A mating section 10c is formed in such a manner that a sheet of plate member 50c represented by a broken line is folded taking as a crease the center axis extending in the mating direction of the plate member 50c (cf. an arrow c), so that both edge portions of the plate member 50c are confronted with one another at one end of the plate member 50c and thereby forming a cavity 52c.

FIG. 13 is a perspective view showing a state of a mating section of the conventional another male contact before the folding processing (cf. Japanese Toku-Kai-Hei 9-147947). A mating section formed at one end of a base 20d is formed in such a manner that a sheet of plate member 50d having a length twice the mating section extending along the mating direction is folded at the intermediate section 53d in a longitudinal direction of the plate member, which will be the top of the mating section, toward the side of the base 20d (cf. an arrow d).

FIG. 14 shows another male contact disclosed by the above-mentioned Japanese Patent Publication Gazette. Part (a) of FIG. 14 is a perspective view showing a state of the mating section before bending processing of the mating section of the male contact. Part (b) of FIG. 14 is a perspective view showing a state of the mating section after the bending processing of the mating section of the male contact. A mating section 10e shown in the part (b) of FIG. 14 is formed by performing the bending processing for a sheet of plate member 50e shown in the part (a) of FIG. 14. The bending processing is performed in such a manner that both edge portions 51e and 51e, which extend in the mating direction from a base (not illustrated) to a top portion 54d of a plate member 50e, are folded (cf. arrows e1), and both the edge portions 51e and 51e are confronted with one another at the center of the plate member 50e, and the edge side of the top portion 54d of the plate member is folded to the base side not illustrated (cf. an arrow e2).

Higher density of loading electric components needs compactness of male contacts. However, it is difficult to implement the compactness of mating sections having the conventional aspects as shown in FIG. 10 to FIG. 14 with a plate member having a plate thickness satisfying a desired strength. Specifically, in the event that the mating section 10a formed by folding of both the edges as shown in FIG. 10 is formed using a plate member having a plate thickness satisfying a desired strength, the narrower width w (cf. FIG. 10) of the mating section, it is more difficult to perform folding both the edges. Even if processing for the folding of both the edges is carried out, a section of the mating section is easy to be a circle in its shape. This will cause a contact area with an elastic contact segment of the female contact to be small, and thus there is a possibility that a reliability of the electric contact is lowered. Further, the mating section 10b formed by winding of both edge portions as shown in FIG. 11 has no flat portion on the top thereof, so that a contact area with an elastic contact segment of the female contact is small, and thus it is difficult to enhance a reliability of the electric contact. In the event that the mating section 10c formed by folding taking the center axis as a crease as shown in FIG. 12 is formed using a plate member having a plate thickness satisfying a desired strength, the narrower width w of the mating section, the more arc-like shape the folding side is concerned with. This will cause a contact area with an elastic contact segment of the female contact to be small, and thus it is difficult to enhance a reliability of the electric contact. In the event that the mating section formed by bending processing by folding to the base side as shown in FIG. 13 needs a plate member having twice length of the mating section extending along the mating direction. This involves a basic problem that the production efficiency is not so good and a yield rate of the materials is low, while the contact area is secured. The mating section 10e formed by folding of three points as shown in FIG. 14 is associated with a possibility that an elastic contact segment of the female contact is damaged by a seam on an upper surface of the mating section, as well as the basic problem that the production efficiency is inefficient.

In view of the foregoing, it is an object of the present invention to provide a male contact solving the above-mentioned problem, or a male contact which is high in reliability of an electric contact with the female contact and has a mating section capable of being formed with a compactness using a plate member having a plate thickness satisfying a desired strength.

### DISCLOSURE OF THE INVENTION

The present invention provides a male contact formed by folding a sheet of metallic plate, said male contact comprising a base and a mating section adapted to mate with a female contact, characterized in that said mating section is formed in such a manner that two sheets of plate members, which individually extend from said base, are superposed on one another by folding on said base; said two sheets of plate members superposed on one another have each a flat section extending in an mating direction and formed flat on an associated outer surface opposite to surfaces on which said two sheets of plate members are in contact with one another; and a tip of one of said two sheets of plate members is folded to overlap a tip of another.

In the male contact according to the present invention as mentioned above, it is preferable that said mating section has a projecting section on one of said two sheets of plate members superposed on one another, said projecting section projecting toward another plate member, and a recess portion adapted to mate said projecting section with said another plate member.

### BRIEF DESCRIPTION OF THE DRAWINGS

FIG. 1 is a perspective view of a male contact of an embodiment of the present invention.

FIG. 2 is a left side elevation of the male contact of FIG. 1.

FIG. 3 is a plan view of the male contact of FIG. 1.

FIG. 4 is a right side elevation of the male contact of FIG. 1.

FIG. 5 is a bottom view of the male contact of FIG. 1.

FIG. 6 is a front view of the male contact of FIG. 1.

FIG. 7 is a sectional view taken along the line A-A of FIG. 5.

FIG. 8 is a sectional view taken along the line B-B of FIG. 5.

FIG. 9 is a sectional view taken along the line C-C of FIG. 3.

FIG. 10 is a sectional view of a mating section of the conventional male contact taken along the direction perpendicular to the mating direction.

FIG. 11 is a sectional view of a mating section of another conventional male contact taken along the direction perpendicular to the mating direction.

FIG. 12 is a sectional view of a mating section of further another conventional male contact taken along the direction perpendicular to the mating direction.

FIG. 13 is a perspective view showing a state of a mating section of the conventional another male contact before the folding processing.

FIG. 14 shows another conventional male contact. Part (a) of FIG. 14 is a perspective view showing a state of the mating section before bending processing of the mating section of the male contact. Part (b) of FIG. 14 is a perspective view showing a state of the mating section after the bending processing of the mating section of the male contact.

### BEST MODE FOR CARRYING OUT THE INVENTION

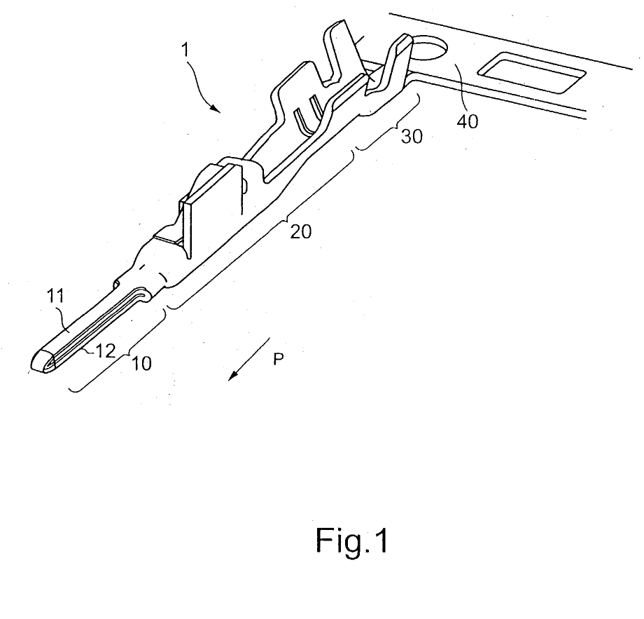

Embodiments of the present invention will be described hereinafter. FIG. 1 is a perspective view of a male contact of an embodiment of the present invention. A male contact 1 is formed by bending processing of a sheet of metallic plate such as a copper alloy. The male contact 1 is provided with a mating section 10 at one end of a base 20, and a wire connecting section 30 at another end of the base 20. A plurality of male contacts 1 is coupled with a carrier 40 at another end of the wire connecting section 30, and is separated from the carrier 40 when the male contacts 1 are actually used. The wire connecting section 30 electrically connects wires (not illustrated). The mating section 10 mates with a female contact (not illustrated) in an mating direction P to electrically connect with an elastic contact section (not illustrated) of the female contact. The mating section 10 has two sheets of plate members 11 and 12 individually extending from the base 20. Those two sheets of plate members 11 and 12 are substantially the same as one anther in geometry excepting the tip and individually extend along the mating direction P. The mating section 10 is formed in such a manner that those two sheets of plate members 11 and 12 are folded on the base 20 to be superposed on one another. Thickness (0.64 mm in the present embodiment) of the mating section 10, which is the narrowest part of the parts of the male contact 1, is about a little longer than twice the plate thickness (0.25 mm in the present embodiment) of the plate member. Thus, it is possible to implement a compactness of the mating section using the plate member having a plate thickness satisfying a desired strength, and also it is easy in processing. A plurality of male contacts 1 is fixed on an insulating housing (not illustrated) and is used as an electrical connector.

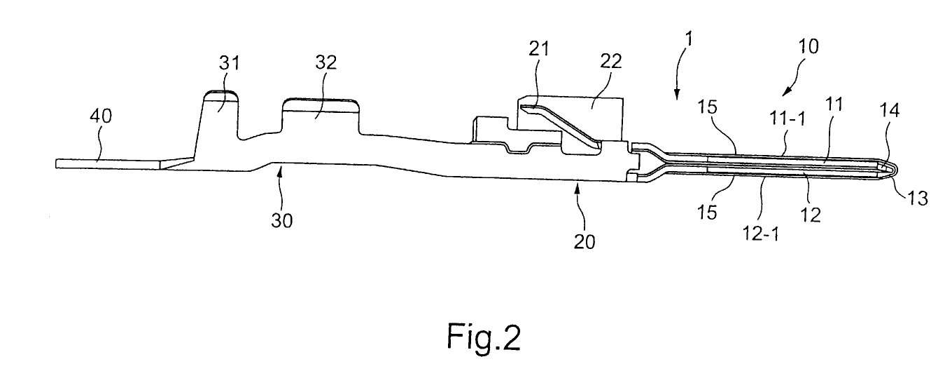

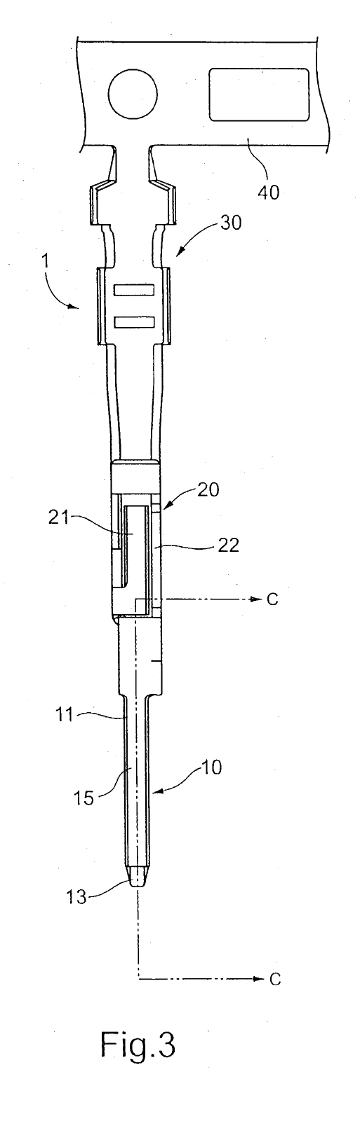

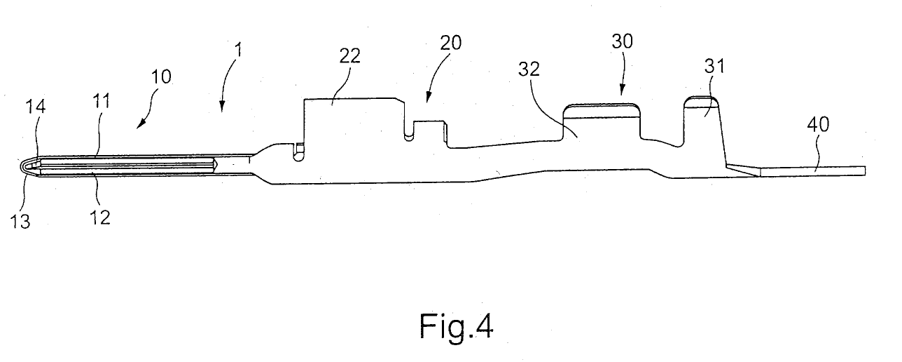

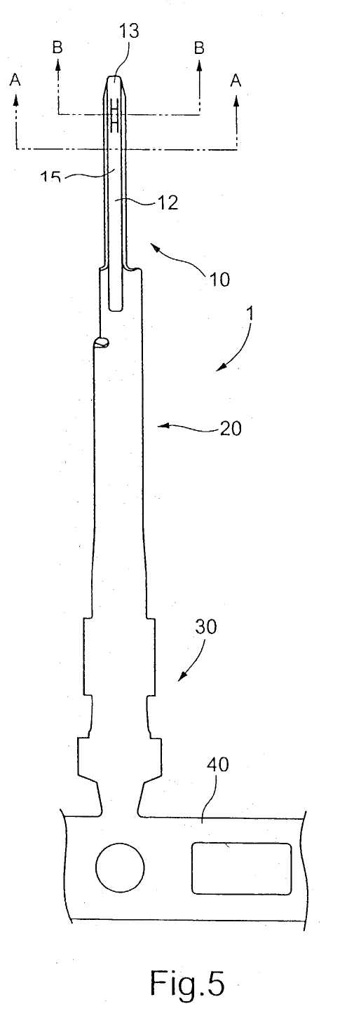

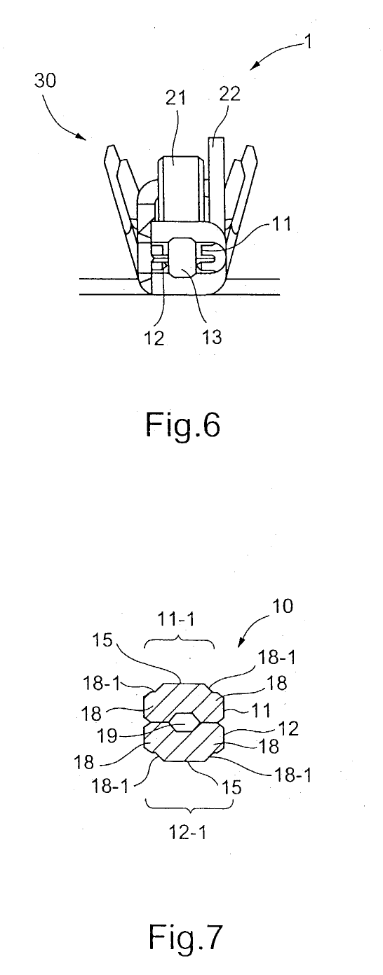

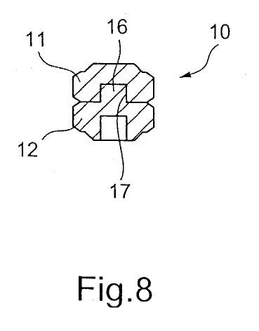

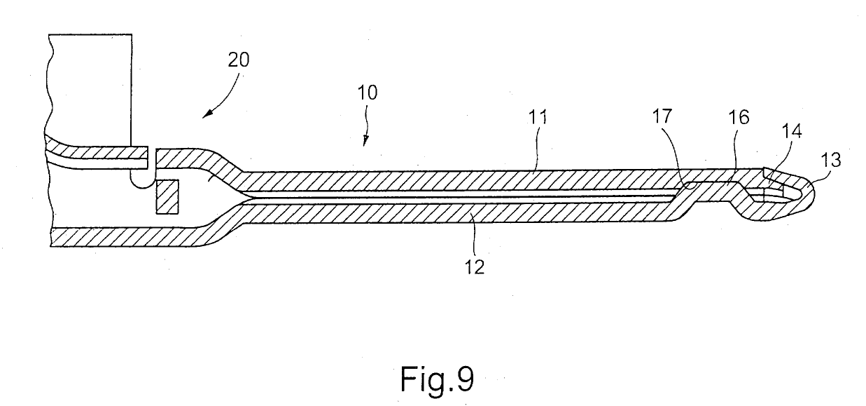

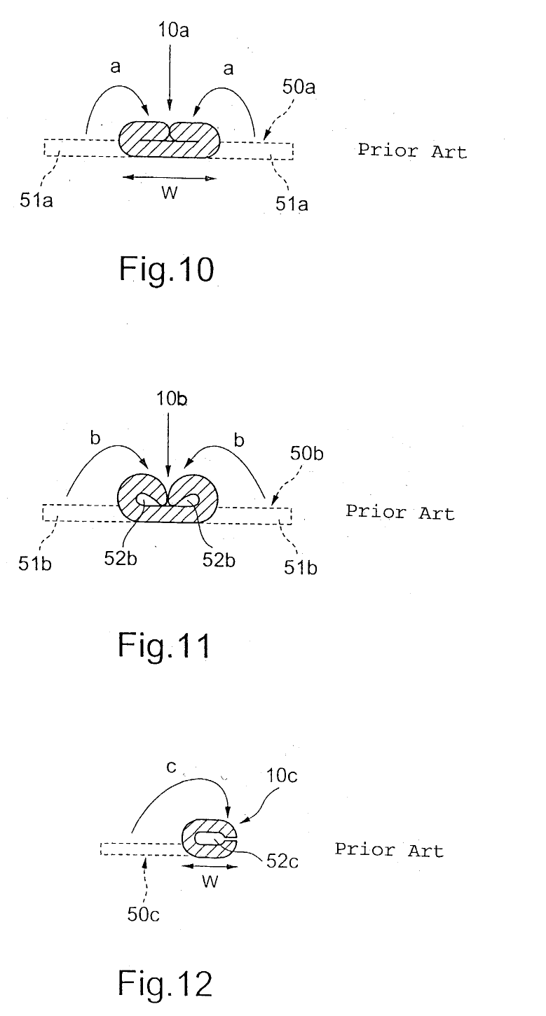

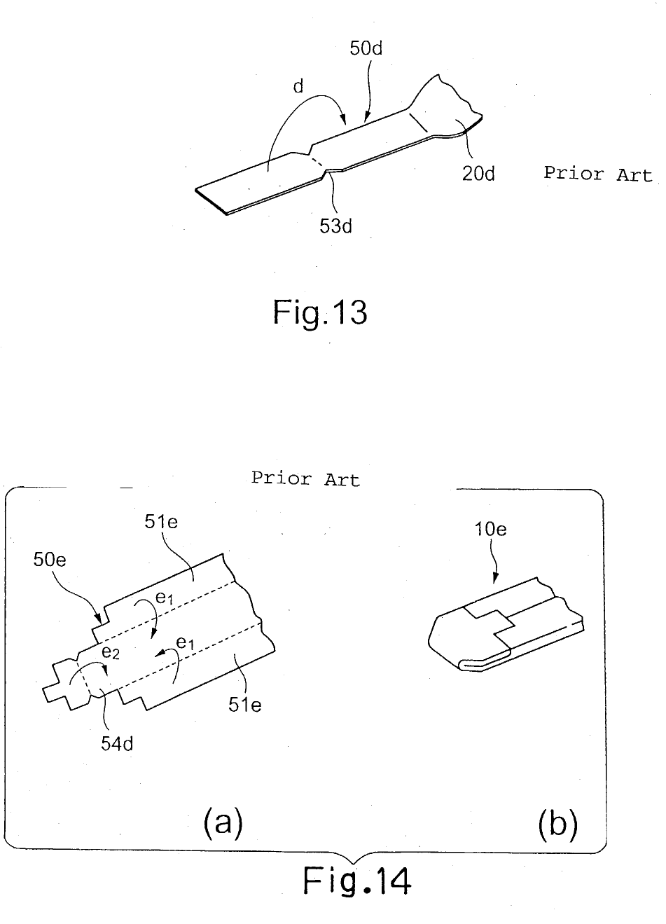

Hereinafter, there will be explained the male contact 1 using FIG. 2 to FIG. 9 taking the mating section 10 as a leading part. FIG. 2 is a left side elevation of the male contact of FIG. 1. FIG. 3 is a plan view of the male contact of FIG. 1. FIG. 4 is a right side elevation of the male contact of FIG. 1. FIG. 5 is a bottom view of the male contact of FIG. 1. FIG. 6 is a front view of the male contact of FIG. 1. FIG. 7 is a sectional view taken along the line A-A of FIG. 5. FIG. 8 is a sectional view taken along the line B-B of FIG. 5. FIG. 9 is a sectional view taken along the line C-C of FIG. 3.

In FIG. 7, on the respective surfaces (outer surfaces) of two sheets of plate member opposite to the contacting surface of the mutually superposed two sheets of plate members 11 and 2, that is, an upper surface 11_1 of the plate member 11 and a lower surface 12_1 of the plate member 12, there are provided flat portions 15 and 15, respectively. The provision of the flat portions 15 and 15 makes it possible, even if the mating of the male contact with the female contact shifts somewhat in right and left directions in FIG. 7, to secure a contact with an resilient contact beam of the female contact and thus to guarantee a desired contact force. Accordingly, the male contact is high in reliability of the electric contact with the female contact. Incidentally, according to the preferred embodiment, a cross sectional size of the mating section 10 is 0.64 mm×0.64 mm, and width of the flat section 15 is secured with about 0.3 mm.

As shown in FIG. 2, a tip 13 of the plate member 12 of the lower side is folded to overlap on a tip 14 of the plate member 11 of the upper side. This folding makes it possible to fix the plate members 11 and 12 on each other not so as to be separated in the vicinity of the tips. According to the present embodiment, thickness of the plate members 11 and 12 is 0.25 mm. Thus, if the tip 13 of the plate member 12 of the lower side is simply folded on the tip 14 of the plate member 11 of the upper side, thickness of this folding section would become about 0.75 mm. For this reason, as apparent from FIG. 9, the tips 14 and 13 of the plate members 11 and 12 are formed thin by coining and the like, and those thinner sections 13 and 14 are superimposed each other, so that the plate thickness is formed within a desired value (according to the embodiment, 0.64 mm). Alternatively, it is acceptable that shapes of the tips 13 and 14 of the plate members 11 and 12 are formed in such a way that when the plate members 12 and 11 are superimposed each other, the tips 13 and 14 are mutually out of place in the right and left of FIG. 3, and the tip 13 of the plate member 12 of the lower side is obliquely folded to the side of the plate member 11 of the upper side and the tip 14 of the plate member 11 of the upper side is obliquely folded to the side of the plate member 12 of the lower side, so that the tip of one of the plate members 11 and 12 is overlapped with the tip of another.

As shown in FIG. 8 and FIG. 9, in the vicinity of the center of the plate member 12 of the lower side of the plate members 11 and 12 constituting the mating section 10, there is provided a projecting portion 16 projecting toward the plate member 11 of the upper side. The plate member 11 of the upper side is provided with a recess portion 17, which mates with the projecting portion 16, in the vicinity of center of the plate member. The projecting portion 16 and the recess portion 17 are formed by press processing before superimposing two sheets of plate members 11 and 12, and are mated by superimposing those two sheets of plate members 11 and 12. Mating of the projecting portion 16 and the recess portion 17 may prevent the mutual deviation of the two sheets of plate members 11 and 12 in a horizontal direction perpendicular to the mating direction P (cf. FIG. 1).

On the male contact 1, there are additionally formed a base 20 and a wire connecting section 30. As shown in FIG. 2, the base 20 has a lance 21 for fixing the male contact 1 on housing (not illustrated) and a stabilizer for stabilizing the posture of male contact 1 with in the housing. The wire connecting section 30 has an insulation barrel 31 for fixing a covering section (not illustrated) of a wire and a wire barrel 32 electrically connecting with a core of a wire. The insulation barrel 31 and the wire barrel 32 apply the covering section and the core wire respectively by a folding processing.

Incidentally, according to the present embodiment, the thinner plate thickness of the plate members 11 and 12, the more saving of materials and processing (fabrication) of the male contact 1 becomes easier. Thus, the male contact 1 is fabricated with a metallic material having the lowest plate thickness satisfying a desired strength as a result of a strength computation. On the other hand, width and height of the mating section are defined by a standard and the like. According to the present embodiment, in order to provide the lowest plate thickness satisfying a desired strength for a plate thickness of the plate member and also satisfy conditions of width and height of the mating section defined, as shown in FIG. 7, there are provided legs 18, 18, 18 and 18 obliquely standing with respect to the opposite direction to the associated plate member in the vicinity of both the edges extending along the respective mating direction P (cf. FIG. 1) of the two plate members 11 and 12. Slants 18_1, 18_1, 18_1 and 18_1, which incline toward the flat sections 15 and 15 side of the legs 18, are slants necessarily formed for forming the mating section 10 having thickness 0.64 mm using two plate members each having the plate thickness 0.25 mm according to the present embodiment. Slants 18_1, 18_1, 18_1 and 18_1 also function as planing off the corners of the edge portions extending along the mating direction P of the mating section 10. This feature makes it possible to prevent the female contact from being damaged at the time of mating. Further, as the legs 18, 18, 18 and 18 are formed, a cavity 19 is formed in the vicinity of the center axis of the mating section 10 extending the mating direction P so that the same effect as forming of beads on the plate members 11 and 12 is obtained. This feature makes it possible to enhance the mechanical strength of the mating section 10.

While the above explanation is made for the preferred embodiment of the present invention, the present invention is not restricted to the present embodiment, and can be modified within the spirit of the present invention as an occasion arises. For example, it is acceptable that the tip of the plate member 11 of the upper side is folded on the tip of the plate member 12 of the lower side. Alternatively, it is acceptable that the plate member 11 of the upper side is provided with a projecting portion projecting toward the plate member 12 of the lower side, and the plate member 12 of the lower side is provided with a recess portion mating with the projecting portion.

According to the male contact disclosed in claim 1, in the male contact formed by folding a sheet of metallic plate, said male contact comprising a base and a mating section adapted to mate with a female contact, said mating section is formed in such a manner that two sheets of plate members, which individually extend from said base, are superposed on one another by folding on said base; said two sheets of plate members superposed on one another have each a flat section extending in an mating direction and formed flat on an associated outer surface opposite to surfaces on which said two sheets of plate members are in contact with one another; and a tip of one of said two sheets of plate members is folded to overlap a tip of another. This feature makes it possible to provide a male contact which is high in reliability of an electric contact with the female contact and has a mating section capable of being formed with a compactness using a plate member having a plate thickness satisfying a desired strength, wherein the tips of the two sheets of plate members are hard to open.

Further, according to the male contact disclosed in claim 2, said mating section has a projecting section on one of said two sheets of plate members superposed on one another, said projecting section projecting toward another plate member, and a recess portion adapted to mate said projecting section with said another plate member. This feature makes it possible to prevent the mutual deviation of the two sheets of plate members in a horizontal direction perpendicular to the mating direction.

What is claimed is:

1. A male contact formed by folding a sheet of metallic plate, said male contact comprising a base and a mating section adapted to mate with a female contact,
wherein said mating section is formed in such a manner that two sheets of plate members, which individually extend from said base, are superposed on one another by folding on said base,
said two sheets of plate members superposed on one another have each a flat section extending in an mating direction and formed flat on an associated outer surface opposite to surfaces on which said two sheets of plate members are in contact with one another, and
a tip of one of said two sheets of plate members is folded to overlap a tip of another.

2. A male contact according to claim 1, wherein said mating section has a projecting section on one of said two sheets of plate members superposed on one another, said projecting section projecting toward another plate member, and a recess portion adapted to mate said projecting section with said another plate member.
